(19) United States
(12) Patent Application Publication
(10) Pub. No.: US 2019/0049652 A1
(43) Pub. Date: Feb. 14, 2019

(54) LIGHT-GUIDE DEVICE

(71) Applicant: National Taiwan Normal University, Taipei (TW)

(72) Inventors: Tun-Chien Teng, Taipei (TW); Chun-Hao Bruce Sun, Taipei (TW)

(21) Appl. No.: 15/676,606

(22) Filed: Aug. 14, 2017

(51) Int. Cl. F21V 8/00

(52) U.S. Cl. CPC G02B 6/0036; G02B 6/005; G02B 6/0046; G02B 6/0055

(57) ABSTRACT

The present invention provides a light-guide device, comprising a transmission body and a light filter, wherein one end of the transmission body receives incident light, and the other end emits highly collimating light; a microstructure portion is disposed on at least a part of the surface thereof; and a reflecting portion is disposed on an inner surface. The light filter is disposed on an outer surface adjacent to the other end of the transmission body, and has a refractive index less than that of the transmission body. After light enters the transmission body from one end, under the matching of the reflecting portion and the microstructure portion, the light travels in the transmission body along a path; and before leaving the transmission body from the other end, light greater than a specific angle is absorbed and eliminated by the light filter, thus highly collimating and uniform light is emitted.

### BACKGROUND OF THE INVENTION

### 1. Field of the Invention

The present invention relates to a light-guide device, in particular to a light-guide device capable of providing highly collimating and uniform light.

### 2. Description of the Prior Art

With the rapid development of science and technology, people have a higher and higher requirement for the display resolution of a digital product, which requires to improve the collimating degree of the emitted light. A conventional technique uses a compound parabolic collector (CPC, or CPC-like) to transform the light from Lambertian distribution to collimating distribution. The distribution relationship between the light received and emitted thereby and angles complies with the following equation:

$$\frac{{A}_{1}}{{A}_{2}} = {( \frac{{n}_{2} sin ( {θ}_{2} )}{{n}_{1} sin ( {θ}_{1} )} )}^{2}$$

Wherein A₁ and A₂ respectively denote the sectional areas of the light receiving end and light emitting end of the CPC; n₁ and n₂ are the refractive index of respective medium; θ₁ and θ₂ respectively denote the angular distribution of the light receiving end and light emitting end of the CPC. Considering a two-dimensional CPC, the aforesaid equation can be rewritten as:

$$\frac{{W}_{1}}{{W}_{2}} = \frac{{n}_{2} sin ( {θ}_{2} )}{{n}_{1} sin ( {θ}_{1} )}$$

Wherein W₁ and W₂ respectively denote the widths of the light receiving end and light emitting end of the CPC.

According to the aforesaid equations, people can deduce that when the angle of the received incident light is fixed, the greater the sectional area proportion difference between the light receiving end and the light emitting end is, the more collimating the emitted light is. In other words, in order to transform Lambertian light to collimating light, the sectional area of the light emitting end of the CPC should be great, namely the width and thickness thereof should be both great. However, the great size of the light emitting end means that the CPC cannot be applied to a thin product. If the thickness of the light emitting end is reduced, then the angular distribution of the emitted light will increase in a corresponding direction, with the result that the CPC cannot emit highly collimating light. Besides the aforesaid to-be-solved problem, the uneven spatial distribution of the emitted light when the CPC is used is another problem to be solved.

An U.S. Pat. No. 9,465,158B2 provides a slim light-guide coupler for modulating angular and spatial distributions of a light source: an input and an output are respectively disposed at the two ends of the coupler, and are connected to each other via a closed curved surface; and an array type microstructure is disposed on a part of (the upper surface or lower surface of the closed curved surface, or both, even the entire) the surface of the coupler. The section shape of the microstructure can be an isosceles triangle, a right triangle, or a square. When the light of a light source enters the input of the coupler, the light can transmit to the output via a total reflection surface or a reflection surface. In the process of transmission, the light will constantly collide back and forth between the array type microstructure and the closed curved surface. Under the continuous action of such a mechanism, the angular distributions of the light finally emitted by the coupler on the vertical plane and horizontal plane approach, thus modulating the angular and spatial distributions of the light source.

However, although the method can concentrate most light in a small angular distribution range, a small amount of light is still distributed in a large angle range, and is easy to become scattering light after entering a subsequent optical system, thus influencing the subsequent light application efficiency. Especially for an application requiring the emitted light to be extraordinarily collimating, such designed CPC requires a long structural body, which restricts the application range thereof, thus the CPC is necessary to be improved.

### SUMMARY OF THE INVENTION

To solve the aforementioned technical problems, the present invention relates to a light-guide device which can be installed on a light source to be modulated in a collimating distribution; when the light emitted by the light source enters the light-guide device, the light-guide device modulates the light, and then emits highly collimating light.

To achieve the aforementioned objective and effect, the present invention provides a light-guide device, comprising a transmission body and a light filter, wherein the transmission body is provided with two ends; at least one curved portion is formed between the two ends; and the two ends are connected via a closed surface. A reflecting portion is disposed on the inner surface of the transmission body; and a microstructure portion is disposed on at least a part of the surface (the upper surface or lower surface of the closed curved surface, or both, even the entire) of the transmission body, and comprises a plurality of microstructure units. When one end of the transmission body receives light from an incident light source (for example, an LED light source), the light enters the transmission body, and transmits to another end of the transmission body under the reflection or total reflection of the reflecting portion. In the process of transmission, the light is constantly reflected and collides back and forth among the curved portion, the microstructure and the reflecting surface of the transmission body, so as to generate a light transmission path, thus changing the angular and spatial distributions of the light source. For example, under the conditions that the width (namely the horizontal direction) of the transmission body is much greater than the thickness (namely the vertical direction) and the microstructure units are arranged in an array manner on the horizontal surface of the transmission body, when colliding with the microstructure units, the large angle traveling light in the vertical direction will be reflected to be large angle traveling light in horizontal direction; and when the large angle traveling light in the horizontal direction collides with the curved portion of the transmission body, the large angle traveling light will be reflected to be small angle traveling light in the horizontal direction.

Wherein the light filter is made from a low refractive index material (the refractive index is relatively less than that of the material of the transmission body), and is disposed on an outer surface adjacent to the other end of the transmission body. After the light passes through the transmission body, the angular distribution is gradually converged, and simultaneously a homogeneous light mixing effect is generated; when a small amount of light in a travelling direction greater than a specific angle collides with the light filter, such part of light will be directly refracted into the light filter due to the small difference (compared to the difference between the refractive indexes of the transmission body and the air) between the refractive indexes of the materials on the two sides of the joint, but will not reach the outlet; and the other light continues to travel without being influenced, and is emitted out from the other end of the transmission body. The specific angle can be controlled according to the difference between the refractive indexes of materials of the transmission body and the light filter.

To sum up, the present invention has one or more of the following advantages:
1. Converging light angles to achieve a highly collimating effect with the energy distributed uniformly and without reducing the light intensity at the center; and
2. Reducing size for applying to a small device.

### BRIEF DESCRIPTION OF THE DRAWINGS

FIG. 1 is a structural diagram of the light-guide device of the present invention;

FIG. 2 is a section view of the light-guide device of the present invention;

FIG. 3 is a section view of another embodiment of the present invention;

FIG. 4 is a section view of still another embodiment of the present invention;

FIG. 5 is an angular distribution diagram of the light emitted by a light-guide device in the prior art;

FIG. 6 is an angular distribution diagram of the light emitted by the light-guide device of the present invention;

FIG. 7 is a diagram for comparing the vertical angular distributions of the light emitting ends of the present invention and in the prior art.

FIG. 8 is an angular distribution diagram of the emitted light, wherein (a) the prior art and (b) embodiment.

### DETAILED DESCRIPTION OF THE PREFERRED EMBODIMENT

To fully understand the objective, features and effects of the present invention, the present invention will be elaborated hereafter in conjunction with drawings and the following preferred embodiments:

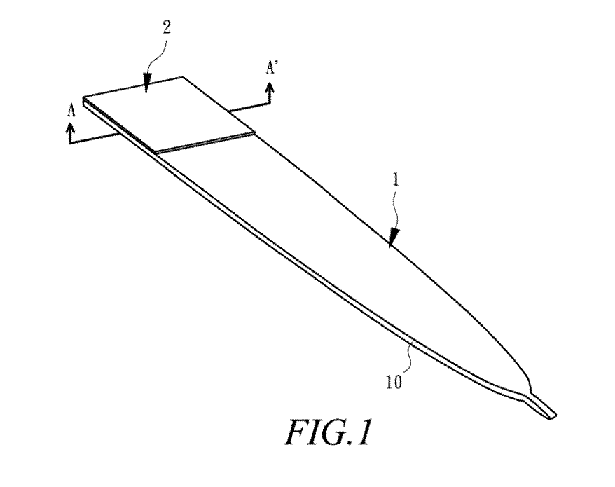

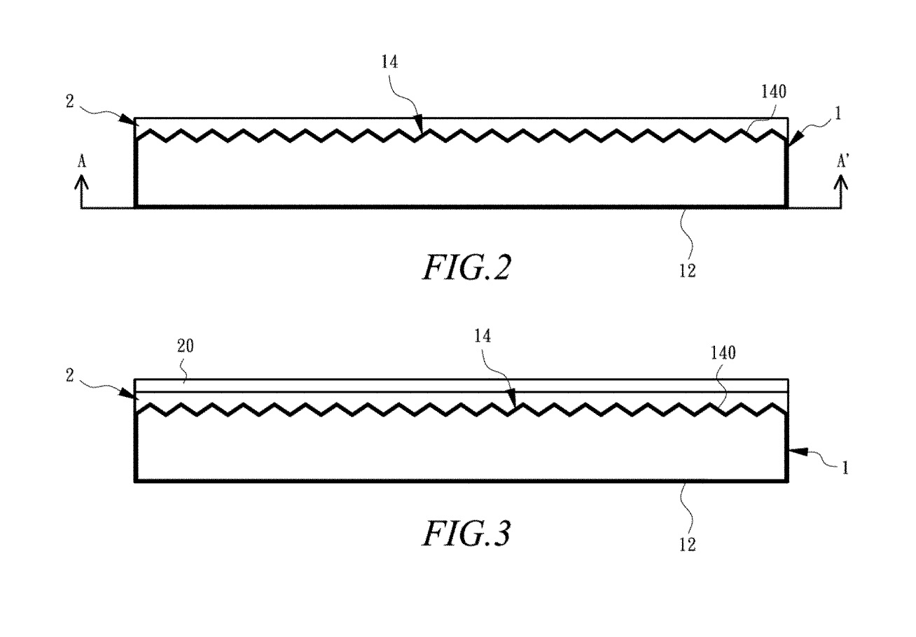

As shown in FIG. 1 and FIG. 2, the light-guide device of the present invention can be installed on a light source to be modulated in a collimating distribution, and the preferred embodiment thereof comprises: a transmission body 1 and a light filter 2, wherein one end of the transmission body 1 receives incident light, and the other end emits highly collimating light; the transmission body 1 comprises: a curved portion 10, a reflecting portion 12 and a microstructure portion 14, wherein the curved portion 10 is formed between one end and the other end of the transmission body 1, and can guide the light to travel from one end to the other end; the reflecting portion 12 is disposed on an inner surface of the transmission body 1, and is used for reflecting or totally reflecting the light; and the microstructure portion 14 comprises a plurality of microstructure units 140, and is disposed on at least a part of the surface (for example the upper surface or the lower surface, or both, even the entire) of the transmission body 1; and the light filter 2 is disposed on an outer surface (for example the upper surface or the lower surface, or both) adjacent to the other end of the transmission body 1, and is used for eliminating the light greater than a specific angle. The light filter 2 can be disposed on the transmission body 1 in a glue or adhesion manner, but not limited to such manner.

In the light-guide device of the present invention, when the light in a Lambertian distribution enters the transmission body 1 from the incident light receiving end thereof, the light is reflected or totally reflected by the reflecting portion 12. The curved portion 10 can transmit the light from the incident light receiving end of the transmission body 1 to another end along a light transmission path, thus the large angle traveling light in the horizontal direction is transformed into small angle traveling light in the horizontal direction. In addition, in the process of transmission, the microstructure portion 14 can rotate the traveling light in different directions. Therefore, the large angle traveling light in the vertical direction originally is gradually transformed into large angle traveling light in the horizontal direction; then the large angle traveling light in the horizontal direction is transformed into small angle traveling light in the horizontal direction under the reflection action of the curved portion 10; and finally the small angle traveling light is gradually rotated to another direction under the action of the microstructure portion 14. In the process above, the light in different directions gradually converges and approaches to the same angle, is fully mixed to uniformly distribute the energy in the process of traveling. Then, before the light leaves the transmission body 1 from the other end thereof, the light passes through the light filter 2 which will eliminate the light greater than a specific angle and filter the scattering light. In the meanwhile, the traveling light also keeps on rotating constantly under the action of the microstructure portion 14, thus the large angle traveling light in various directions is eliminated by the light filter 2. Therefore, the light leaving the transmission body 1 is highly collimating light.

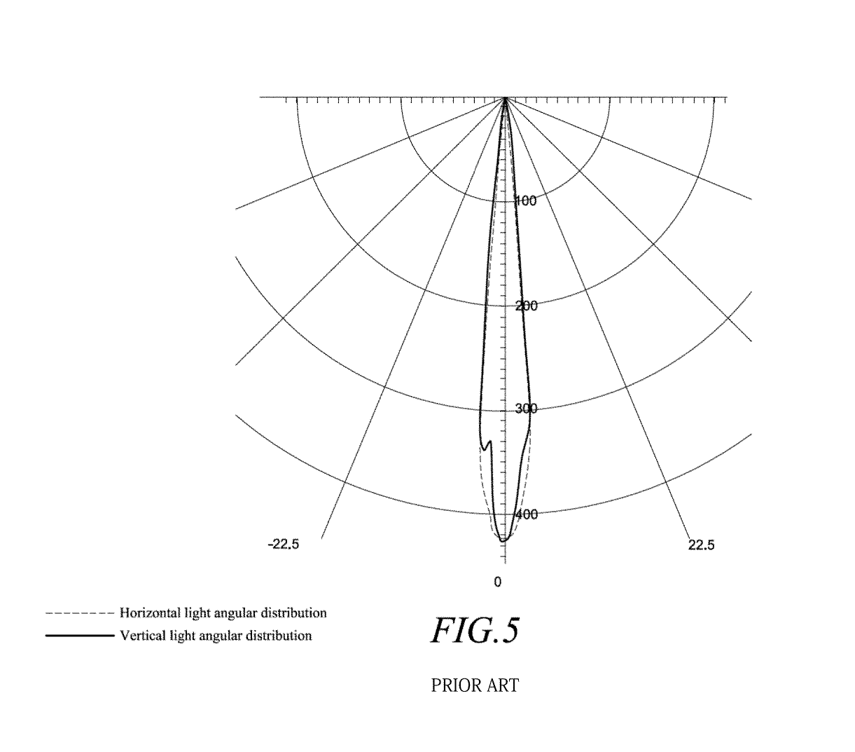

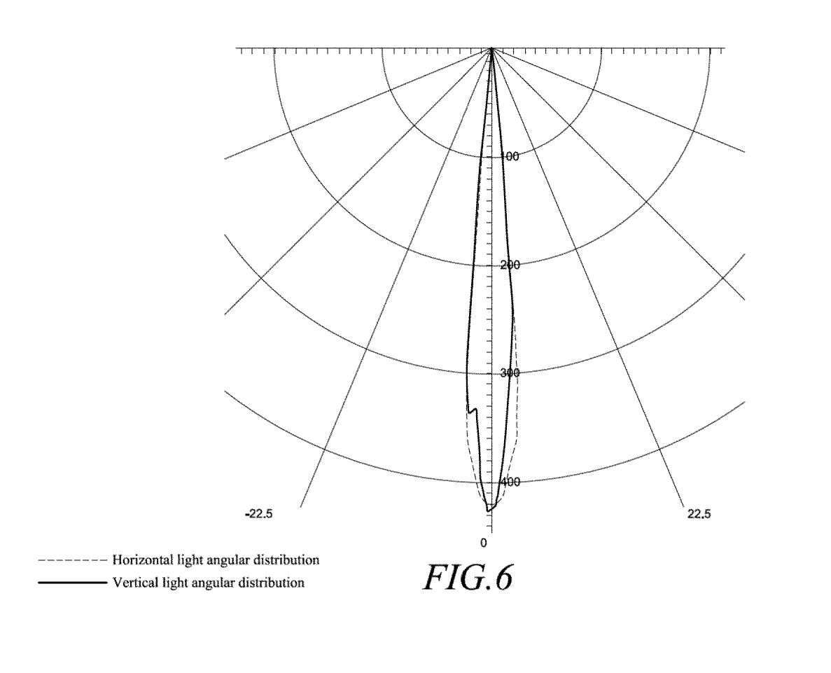

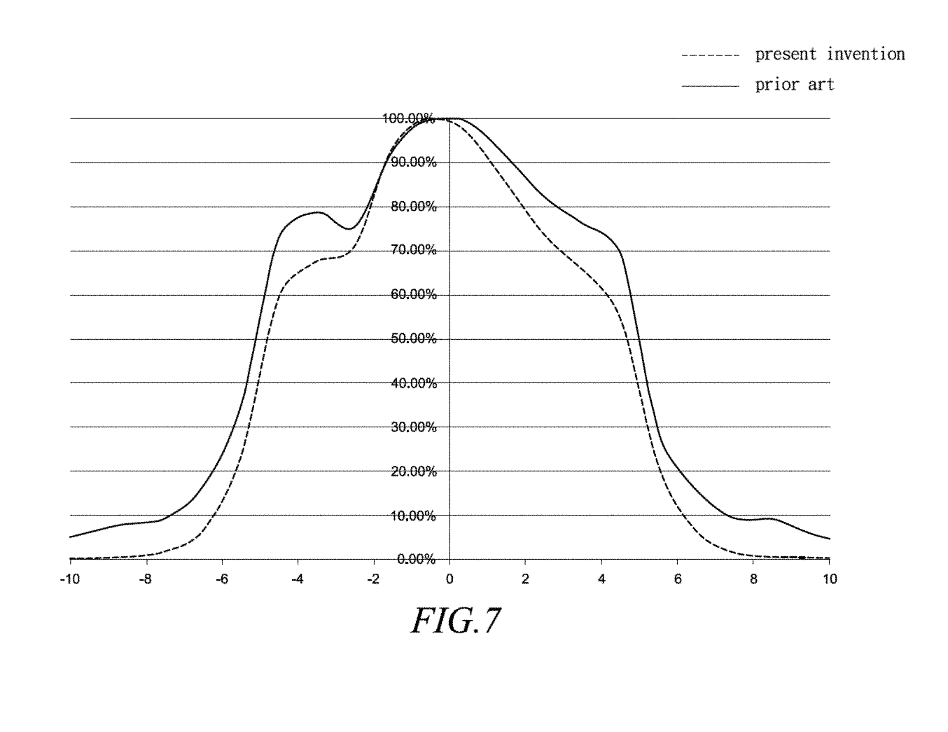

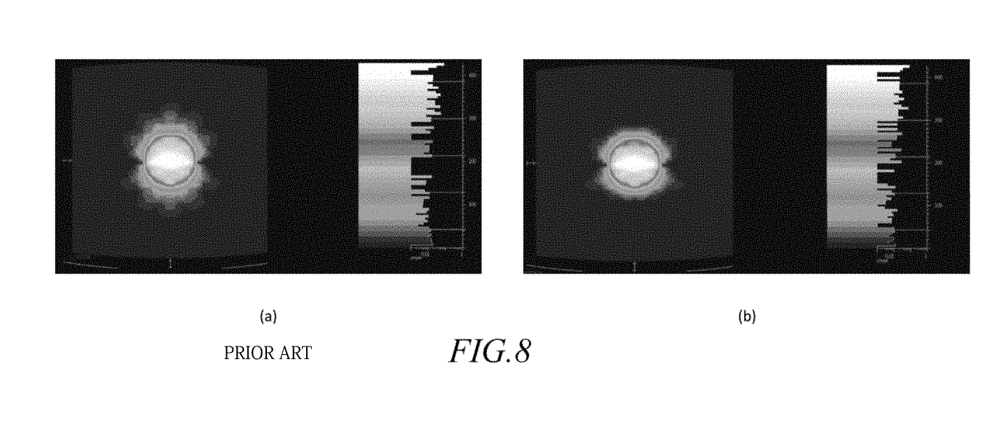

FIG. 5-7 show the light angular distribution diagrams of the light emitting ends of the light-guide device of the present invention and the conventional light-guide device without installing a light filter 2, and a comparison diagram of the two devices, wherein the FIG. 5 is detected from prior art and the FIG. 6 is detected from the present invention. As shown in FIG. 5 and FIG. 6, wherein the solid line is the angular distribution of the vertical (namely the thickness direction of the light-guide device) light and the dotted line is the angular distribution of the horizontal (namely the direction from A to A′ in FIG. 1) light, the the angular distribution of the vertical light in FIG. 6 is more concentrated than that in FIG. 5, namely FIG. 6 has less scattering light. Furthermore, as can be obviously seen from comparison diagram FIG. 7, in the light having been processed by the light-guide device of the present invention, the light at the angles greater than ±6 degrees has been obviously effectively reduced, and the light at the angles greater than ±8 degrees is reduced to almost 0. Therefore, the light-guide device of the present invention can improve the collimating degree of the light. Further, as shown in FIG. 8, the color bar on the right side of the angular distribution diagram of the emitted light denotes the intensity of light; the upper, the stronger light intensity the color denotes, whereas the weaker. To understand FIG. 8 through the color bar, the angular distributions of the emitted light of the present invention are converged not only in the vertical direction, but also in the other directions.

In one preferred embodiment of the present invention (refer to FIG. 3), comparing with FIG. 2 the light-guide device further comprises an absorption unit 20, wherein the absorption unit 20 is disposed on the outer surface of the light filter 2, and can absorb the light greater than a specific angle entering the light filter 2, such that the light greater than a specific angle will not enter the transmission body 1, thus eliminating the scattering light.

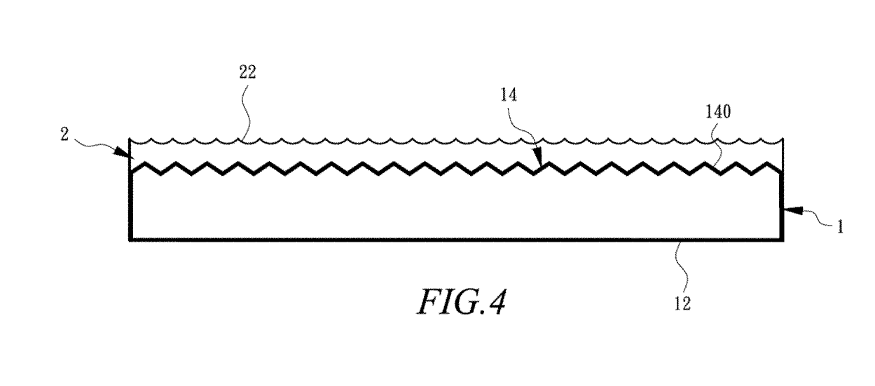

In another preferred embodiment of the present invention (refer to FIG. 4), comparing with FIG. 2 the outer surface of the light filter 2 of the light-guide device is a rough surface 22 which can guide the light greater than a specific angle entering the light filter 2 out of the light filter 2, then enable the light greater than a specific angle to leave the transmission body 1, and ensure the light greater than a specific angle not to enter the transmission body 1 again.

In the embodiments, the material of the transmission body 1 is at least selected from one of PMMA, glass, resin, and a combination thereof; and the material of the light filter 2 is at least selected from resin, and the refractive index of the material of the light filter 2 is less than that of the material of the transmission body 1.

In the embodiments, the width of the transmission body 1 gradually increases from one end to the other end, by which the light is guided to travel to the other end; and the reflecting portion 12 is a total internal reflection surface or a closed reflection surface.

In the embodiments, the section shape of the microstructure units 140 can be a polygonal structure such as an isosceles triangle, a right triangle, or a square and the like; and the microstructure units 140 are arranged in an array manner, by which the angles and directions of the light are modulated.

Under the continuous action of the aforesaid embodiments and the light-guide mechanisms thereof, the light travels to the other end of the transmission body 1 along the light transmission path, and the angular distribution thereof in the vertical direction will approach to the angular distribution in the horizontal direction, thus modulating the angular and spatial distributions of the energy of the light source. Before the light leaves the transmission body 1, the light passes through the other end of the transmission body 1 at which position the light filter 2 is installed; the light filter 2 will absorb and eliminate the light greater than a specific angle, and then filter the scattering light, thus converging light angles.

To sum up, the light-guide device of the present invention can guide light into highly collimating and uniform light by modulating the angles of Lambertian light via the transmission body 1, then filtering and converging the modulated light via the light filter 2. In addition, under the assistance of the light filter 2, the size of the transmission body 1 can be reduced, thus solving the problem that the volume necessarily becomes great in order to improve the collimating degree.

The descriptions above specifically and fully disclose the content of relevant technologies in conjunction with preferred embodiments. And a person skilled in the art should understand that the embodiments are only used to describe the present invention, but not to restrict the protection scope of the present invention; after understanding the spirit and principles of the present invention, a person skilled in the art may have various variations and modifications to achieve an equivalent objective, and such variations and modifications shall be all concluded in the protection scope claimed subsequently.

1. A light-guide device, comprising:
a transmission body, one end thereof receiving incident light, and another end emitting collimated light, comprising:
at least one curved portion being formed between the one end and the other end;
a reflecting portion, disposed on a periphery of the transmission body, and reflects light in the transmission body; and
a microstructure portion, disposed on at least a part of a surface of the transmission body, and comprising a plurality of microstructure units;
wherein the curved portion, the reflecting portion and the microstructure portion enable light to form a light transmission path;
a light filter, disposed on an outer surface adjacent to the other end, and used for absorbing and eliminating light greater than a specific angle.

2. The light-guide device as claimed in claim 1, wherein the light-guide device further comprises an absorption unit disposed on an outer surface of the light filter and capable of absorbing the light greater than a specific angle entering the light filter.

3. The light-guide device as claimed in claim 1, wherein an outer surface of the light filter is a rough surface which can keep the light greater than a specific angle entering the light filter away from the transmission body.

4. The light-guide device as claimed in claim 1, wherein a refractive index of a material of the light filter is less than that of a material of the transmission body.

5. The light-guide device as claimed in claim 1, wherein a material of the light filter is at least selected from resin.

6. The light-guide device as claimed in claim 1, wherein the microstructure units are arranged in an array manner.

7. The light-guide device as claimed in claim 1, wherein a width of the transmission body gradually increases from the one end to the other end.
